(19) United States
(12) Patent Application Publication
(10) Pub. No.: US 2024/0020385 A1
(43) Pub. Date: Jan. 18, 2024

(54) SECURE APPLICATION SUGGESTION IN WORKFLOW

(71) Applicants: Belsasar Lepe, Alameda, CA (US); Sergio Pedraza, Guadalajara (MX); Carlos Ortiz, Naucalpan de Juarez (MX); Vidal Gonzalez, Guadalajara (MX)

(72) Inventors: Belsasar Lepe, Alameda, CA (US); Sergio Pedraza, Guadalajara (MX); Carlos Ortiz, Naucalpan de Juarez (MX); Vidal Gonzalez, Guadalajara (MX)

(21) Appl. No.: 18/221,365

(22) Filed: Jul. 12, 2023

Related U.S. Application Data
(60) Provisional application No. 63/368,577, filed on Jul. 15, 2022.

(51) Int. Cl. G06F 21/57

(52) U.S. Cl. CPC G06F 21/57

(57) ABSTRACT

User selection of software application programs (“apps”) may be assisted by prompting a user, in response to initial selection of a particular app, with suggestions as to other potential apps that may be used. A decision as to selection of the app to be used may be left with the user. The suggestions may be provided in response to the user selecting an app or accessing a subscription page for an app.

### CROSS-REFERENCE TO RELATED APPLICATIONS

This application claims the benefit of U.S. Provisional Patent Application No. 63/368,577, filed on Jul. 15, 2022, the disclosure of which is incorporated by reference herein.

### FIELD OF THE INVENTION

The present invention relates generally to selection of software programs for use, and more particularly to automated guidance to alternative software programs.

### BACKGROUND OF THE INVENTION

Workflows across a multitude of industries are performed using computers. The computers may be used in generating a variety of items, which may run the gamut from documents presenting simple text, to spreadsheets including elaborate calculations, to multimedia presentations, and even to software programs which may be used in generating still further items. The generation of these items is usually done using middleware and application software programs running on the computers. The application software programs may provide simple (or not so simple) text editors, complex image analysis and video editing capabilities, and a host of other functions. At times the application software programs may depend on or make use of middleware servicing or linking software applications, particularly when multiple application software programs are to be used.

In many instances, there are also a multitude of possible software programs that may be used to complete any one task in a workflow. Selection of an appropriate software program for the workflow task may present difficulties, particularly for organizations. A variety of factors could be considered in selection of the software program. Ease of use, program capabilities, licensing cost, ease of administration, and, particularly of late, security concerns are just some of the many factors that may go into selection of a particular software program for a particular workflow task.

Unfortunately, domain knowledge regarding these areas may be diffuse in an organization, with different groups and different individuals having greater knowledge in some areas and lesser knowledge in others. Moreover, the different individuals and groups may have significantly different views as to the importance of different concerns. For example, those in an IT or Security department may have greater knowledge relating to security concerns and weight those concerns highly, while those in a procurement department may have greater insights as to initial costs, and weight those concerns highly.

Complicating matters, some workflows may be generated in a rapid fashion. For example, due to evolving needs, some workflows may even be generated in an ad hoc manner. In such circumstances, it may be difficult to arrange for a consensus to be reached among different individuals and groups in an organization as to the appropriate software program to be used for a particular task.

### BRIEF SUMMARY OF THE INVENTION

Some embodiments decentralize selection of use of software applications to the users. Some embodiments do so while providing suggestions to users as to similar software programs that may be used, and in some embodiments maintaining centralized knowledge as to which software programs are selected for use by the users.

Some embodiments provide for user selection of application software programs, with a user prompted, in response to initial selection by a user of a particular application software program, with suggestions as to other potential application software programs that may be used, with the decision as to selection of the application software program to be used remaining with the individual. In some embodiments the other potential application software programs may be determined based on an index, or other data structure, that groups or correlates application software programs with similar functionality. In some embodiments the suggestions may be provided in response to the user accessing a subscription page for the particular application software program.

In some embodiments users in an organization access application software programs using a browser executing on their local computers. In some embodiments the browser includes a plug-in configured, at least in part, to monitor whether the browser has loaded a subscription page for an application software program. In response to the plug-in determining that the browser has loaded a subscription page for an application software program, the plug-in or a software module notified by the plug-in determines suggestions as to other application software programs that may be used.

In some embodiments users in the organization may in addition or instead access software programs on their user compute devices, without using the browser. In some embodiments the user compute devices include agents that monitor for user selection of application software programs. The agents may be, for example, network monitors or other monitoring software. In response to the agent determining that use of an application software program has been selected, the agent or a software module notified by the agent determines suggestions as to other application software programs that may be used.

In some embodiments the other application software programs are selected from a set of application software programs that are registered in an identity provider system for the organization, that are identified in a vendor payment system for the organization, are identified in access rights management software utilized by the organization, and/or have been previously been used, selected for use, or subscribed to by user compute devices. In some embodiments a table, index, or other data structure identifies, for the set of application software programs, those application software programs that have similar functions. In some embodiments those application software programs that have similar functions are provided to the user as suggestions as to other potential application software programs that may be used. In some embodiments the table, index, or other data structure also includes information as to access requirements for the application software programs. The requirements may indicate, for example, whether access to the application software program is limited (within the organization) to a predetermined number of users or seats, and, if so, a number of seats remaining. In some embodiments suggestions as to other potential application software programs that may be used are limited to only those application software programs which do not exceed a number of seats remaining.

Some aspects provide a method of providing application software program (“app”) usage suggestions, comprising: identifying an app desired to be used by a user using a user compute device; identifying alternative apps which provide similar functionality to the app; presenting an indication, on the user compute device, of the alternative apps which provide similar functionality to the app; and receiving a selection, by the user compute device, for use of the app or a one of the alternative apps.

In some aspects the app is identified based on loading of a subscription web page for the app in a browser of the user compute device. In some aspects a plug-in for the browser identifies the app based on the loading of the subscription web page for the app. In some aspects the plug-in for the browser detects loading of the subscription page by examining page content of loaded pages. In some aspects the plug-in for the browser detects loading of the subscription web page by examining page content of loaded pages for log-in fields. In some aspects the plug-in for the browser identifies the app based on information of a title of a loaded subscription page. In some aspects the app is identified based on selection of use of the app by the user compute device. In some aspects the user compute device includes an agent that monitors for user selection of apps. In some aspects the agent comprises network monitoring software. Some aspects further provide sending a message, by the user compute device, to a server indicating the identified app. In some aspects the server identifies the alternative apps which provide similar functionality to the app. In some aspects the identifying alternative apps which provide similar functionality to the app uses a data structure includes information correlating apps which provide similar functionality. Some aspects further provide identifying apps for inclusion in the data structure based on information stored by one, some, or all of user registry systems, identity processing systems, and/or supply chain management systems. In some aspects the data structure includes information as to access requirements for the apps. In some aspects the access requirements for the apps includes a number of seats remaining for the apps. In some aspects the identified alternative apps are limited to only those apps which do not exceed a number of seats remaining. In some aspects the user compute device identifies the alternative apps which provide similar functionality to the app based on information downloaded from a server.

Some aspects provide a system for providing application software program (“app”) usage suggestions, comprising: a server configured by program instructions to: receive an indication that a user compute device obtained a subscription page for an application software program (“app”), determine other apps that have similar functionality to the app; and provide information regarding the other apps to the user compute device.

In some aspects the server is configured by program instructions to determine other apps that have similar functionality to the app based on information of a data structure including information correlating apps which provide similar functionality. In some aspects the server is further configured by program instructions to prioritize the determined other apps based on at least one of a current domain, permissions of a user for the user compute device, and a team membership of the user of the user compute device.

These and other aspects of the invention are more fully comprehended upon review of this disclosure.

### BRIEF DESCRIPTION OF THE DRAWINGS

FIG. 1 is a semi-block diagram of a system including provision of suggestions for use of alternative software programs to a user, in accordance with aspects of the invention.

FIG. 2 is a screenshot of an example app subscription page.

FIG. 3 is an example screenshot of an app subscription page with a suggestion window for alternative apps, in accordance with aspects of the invention.

FIG. 4 is a flowchart of a process including providing suggestions to a user as to alternative apps that may be used instead of an app initially chosen by the user, in accordance with aspects of the invention.

FIG. 5 is a flowchart of an example process for determining suggestions to a user as to alternative apps that may be used instead of an app initially chosen by the user, in accordance with aspects of the invention.

### DETAILED DESCRIPTION

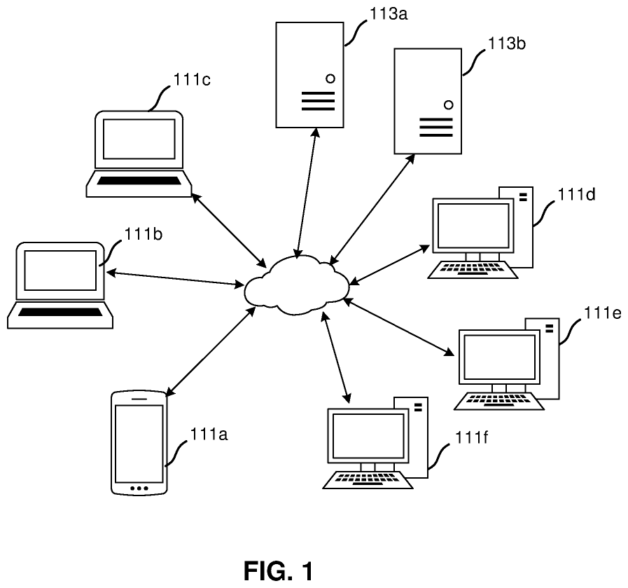

FIG. 1 is a semi-block diagram of a system including provision of suggestions for use of alternative software programs to a user. The system includes a plurality of user compute devices. The user compute device may include, for example, smartphones, for example smartphone 111a, laptop computers, for example laptop computers 111b,c, and desktop computers, for example desktop computers 111d-f. In various embodiments the user compute device may include tablets and/or other computer devices used by users. The user compute devices generally include at least one processor, memory for storing data and program instructions, and network interface capabilities. The user compute devices generally either include a display and user input devices, or, as for example with desktop computers, have associated display and user input devices communicatively coupled to them.

The user compute devices are coupled by a network. The network may be or include, for example, the Internet.

Also coupled to the network are servers, for example, servers 113a,b. Although only two servers are illustrated in FIG. 1, the user compute devices may be coupled by the network to a large number of servers. Some of the servers may include servers providing application software programs, often providing the application software programs by way of software as a service (SaaS) model, with the application software programs sometimes termed SaaS software, SaaS apps, or just apps. For example, server 113a may be configured to provide a SaaS app (with server 113a in some embodiments considered external to the system including provision of suggestions for use of alternative software programs to a user.) One or more of the other servers, for example server 113b, may be configured to provide support for provision of suggestions for use of alternative software programs to a user.

The server 113b may store information indicating apps that have similar functionality. The information may be stored, for example, in a table, a database, or other data structure. The server 113b may also store other information relating to the apps, for example information relating to cost of an additional user using the app (e.g., does the organization to which the user belongs have a general subscription to the app, does the organization have a per seat license to the app and how many seats are available, etc.). The other information may also be stored in the table, database, or other structure. The server 113b is configured to receive an indication that a user compute device has obtained a subscription page for an app, to determine which other apps have similar functionality, and to provide information regarding the other apps to the user compute device.

The server 113b may also be configured to provide additional functions. For example, the server 113b may also be configured to provide identity processing functions or to interface with an app executing on another server providing those functions, to provide user registry functions or to interface with an app executing on another server providing those functions, or to provide vendor payment or supply chain management functions or provide interfaces with apps providing those functions.

In some embodiments the server is configured to identify apps for inclusion in the information indicating apps that have similar functionality by reading information stored by one, some, or all of user registry systems, identity processing systems, and/or vendor payment or supply chain management systems. In some embodiments the server is configured to identify apps for inclusion in the information indicating apps that have similar functionality by storing information of apps which have been subscribed to by user compute devices (or for which app subscription pages have been loaded) or, in some embodiments, apps which have been selected for execution by user compute devices. In some embodiments the server is configured to identify apps for inclusion in the information indicating apps that have similar functionality by storing information of apps which have been used by user computer devices more than a predetermined number of times, and/or which have a frequency of use by user computer devices greater than a predetermined threshold. In some embodiments, whether such identified apps have similar functionality is determined by human correlation, for example either on an app-by-app basis or by placing apps in predetermined groupings or sets.

In some embodiments the user compute devices are configured by program instructions to include a browser interface, with which the user compute devices may access the SaaS apps. Some embodiments utilize a browser plug-in configured to detect loading of an app subscription page by the browser. In some embodiments the plug-in detects subscription pages by examining page content for log-in fields. In some embodiments the plug-in detects subscription pages by other content in the page. In some embodiments the plug-in identifies the app based on content on the page. In some embodiments the plug-in identifies the app based on URL information for the page. In some embodiments the plug-in has information regarding at least some content of subscription pages for each of a plurality of apps, and the plug-in detects subscription pages for those apps by searching pages loaded by the browser for that content. In some embodiments the information regarding at least some content of subscription pages is maintained by a server, for example the server 113b. In some embodiments the server maintains the information regarding at least some content of subscription pages in the table, a database, or other data structure storing information indicating apps that have similar functionality. The plug-in is configured to send a message to the server 113b in response to detecting loading of an app subscription page by the browser. The plug-in, or some other browser component, is also configured to display suggestions for use of alternative apps, received from the server 113b, in a window of the browser.

Some embodiments utilize an agent executing on the user computer devices to detect selection of an app. In some embodiments the agent performs network monitoring in detecting selection of an app. In some embodiments the agent compares information regarding apps which may be selected, and in some embodiments which may be of interest, in determining if the selected app should be the subject of suggestions as to alternative apps. In some embodiments the information regarding apps which may be selected and/or of interest is maintained by a server, for example the server 113b. In some embodiments the server maintains the information regarding apps which may be selected and/or of interest in the table, a database, or other data structure storing information indicating apps that have similar functionality. The agent is configured to send a message to the server 113b in response to detecting selection of an app. The agent, or some other module, is also configured to display suggestions for use of alternative apps, received from the server 113b, in a window of the user compute device.

In operation, a user compute device, operated by a user, may navigate the browser to a subscription page for an app. The plug-in detects loading of the subscription page in the browser and provides a notification to the server that a subscription page for an app has been loaded, along with an identification of the app. The server, in response to receiving the notification, determines suggestions for use of alternative apps, and provides information regarding the alternative apps to the user compute device. The user compute device displays the information regarding the alternative apps in a window of the browser.

Alternatively, a user compute device may receive a user input selecting an app. The app, or a client for the app, may be resident on the user compute device, for example. The agent detects selection of the app and provides a notification to the server that the app has been selected, along with an identification of the app. The server, in response to receiving the notification, determines suggestions for use of alternative apps, and provides information regarding the alternative apps to the user compute device. The user compute device displays the information regarding the alternative apps, for example in a window.

In some embodiments some of the above functions of the server 113b may instead be implemented on the user compute device. For example, the information indicating that apps have similar functions may be stored on the server 113b, and downloaded to the user compute devices. The user compute devices may thereafter determine the suggestions for use of alternative apps in response to detection of loading of an app subscription page, and display the suggestions, without intervention of the server 113b.

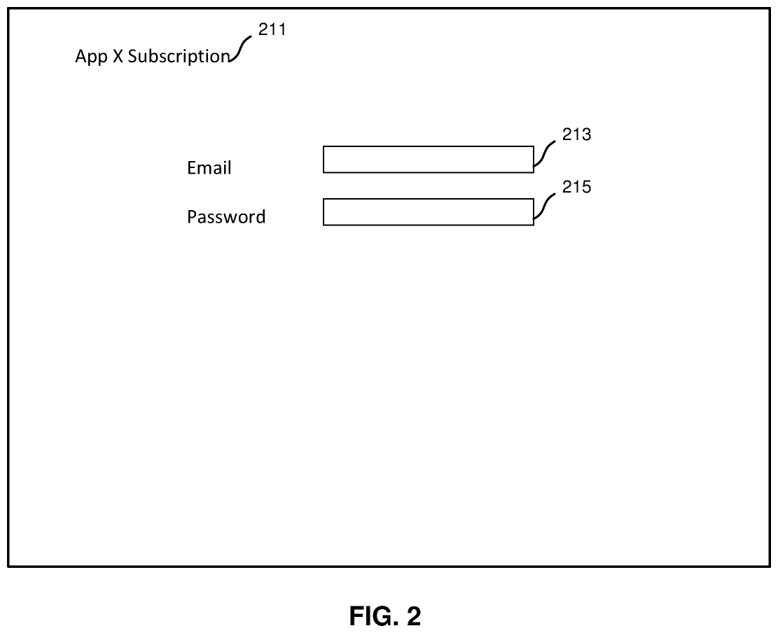

FIG. 2 is a screenshot of an example app subscription page. The app subscription page may be displayed on a display of or associated with a user computer device, or for example in a browser window of such a display. The user compute device may be a user compute device of FIG. 1.

The screenshot of FIG. 2 includes a title 211 and a user log-in area including entry areas for a user name 213 and a password 215. In some embodiments, and as shown in FIG. 2, the requested user name may be an email address. The title may indicate a name of the software app. In some embodiments the browser plug-in discussed with respect to FIG. 1 reads the title to determine a name of the software app. The user name may be, for example, an email address or other identifier for a user. In various embodiments, some app subscription pages may have other entry areas. In some embodiments the plug-in detects presence of user name and/or password entry areas in displayed pages in determining whether the browser is displaying, or possibly displaying, an app subscription page.

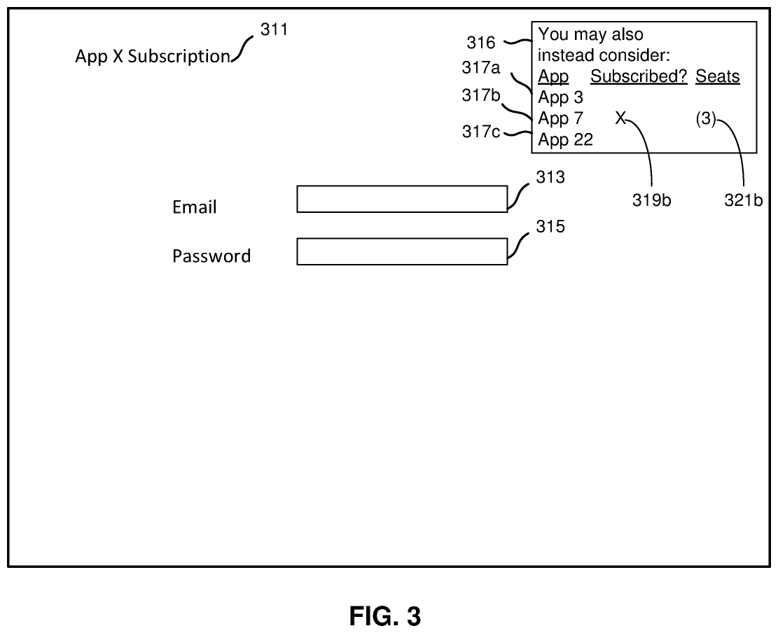

FIG. 3 is an example screenshot of an app subscription page with a suggestion window for alternative apps. As with the app subscription page, the app subscription page with a suggestion window may be displayed on a display of or associated with a user computer device, or for example in a browser window of such a display. The user compute device may be a user compute device of FIG. 1. The suggestion window may be generated for example with a plug-in, which may be the same plug-in as the plug-in that detected the app subscription page in some embodiments.

The app subscription page with a suggestion window includes the title 311 and the login area, including entry areas for an email address and a password, as discussed with respect to FIG. 2. Also as discussed with respect to FIG. 2, various app subscription pages may have other entry areas.

The suggestion window includes text 316 to notify the user of the purpose of the window, namely that the user may wish to consider use of alternative apps. In the suggestion window of FIG. 3, three example alternative apps 317a-c are listed: an App 3, an App 7, and an App 22, respectively. In some embodiments, and as illustrated in FIG. 3, optionally the suggestion window also includes a subscription notation 319b indicating that App 7 is already subscribed by the organization of the user, along with, optionally, a remaining seats notation 321b indicating that 3 seats remain open for the subscription. In some embodiments the window may include links to subscription pages of the alternative apps. In various embodiments choice of the app to use, whether the app of the subscription page or one of the alternative apps, is left to the user.

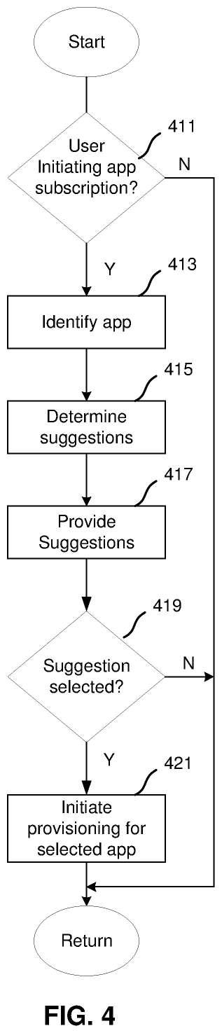

FIG. 4 is a flowchart of a process including providing suggestions to a user as to alternative apps that may be used instead of an app initially chosen by the user. In some embodiments the process of FIG. 4 is performed by a system, for example the system of FIG. 1. In some embodiments the process is performed, at least in part, by a server, for example the server 313b of FIG. 1. In some embodiments the process is performed, at least in part, by a user compute device, for example a user compute device of FIG. 1. In some embodiments the process is performed by one or more processors programmed by program instructions.

In block 411 the process determines if a user compute device, operated by a user, is initiating an app subscription or, in some embodiments, selecting an app for execution. In some embodiments the user compute device initiates an app subscription by loading an app subscription page into a browser. In some embodiments a plug-in for the browser determines that an app subscription page has been loaded. In some embodiments an agent executing on the user compute device determines if an app is selected for execution. If a user compute device is initiating an app subscription, or in some embodiments selecting an app for execution, the process continues to block 413, otherwise the process returns.

In block 413 the process identifies the app, for the app subscription page or the app selected for execution. In some embodiments the plug-in for the browser determines the app based on information of the app subscription page. In some embodiments the plug-in sends a message to a server indicating the app for the app subscription page. In some embodiments the agent determines the selected app, for example by way of network monitoring or other monitoring. In some embodiments the agent sends a message to the server indicating the selected app.

In block 415 the process determines suggestions as to alternative apps that may be used instead of the app. In some embodiments the suggestions are determined using information as to apps that have similar functionality. In some embodiments suggestions as to alternative apps are prioritized based on known similarity to the app, and/or, in some embodiments, based on the current domain, the user's permissions, and/or the user's team membership. In some embodiments the information as to apps that have similar functionality is stored in memory of the user compute device. In some embodiments the user compute device, for example the plug-in, determines the suggestions as to the alternative apps. In some embodiments the information as to apps that have similar functionality is stored in memory of or associated with a server. In some embodiments the server determines the suggestions as to the alternative apps.

In block 417 the process provides suggestions as to alternative apps that may be used instead of the app of the subscription page, or in some embodiments the selected app. In some embodiments the suggestions are displayed in a window of a display of or associated with the user compute device. In some embodiments the suggestions are transmitted from the server to the user compute device, and the user compute device displays the suggestions in a window of a display of or associated with the user compute device. In some embodiments information in addition to information identifying alternative apps is displayed. For example, in some embodiments information indicating whether an organization, of which the user is part, already has a subscription to the alternative apps may also be provided, and in some embodiments information as to remaining seats for apps subscribed to by the organization may also be provided. In some embodiments the process also indicates subscription status, for the organization to which the user belongs, of the app for which the subscription page has been loaded.

In optional block 419 the process determines if one of the alternative apps have been selected. If so, the process goes to block 421 and initiates a provisioning flow for the selected alternative app, and thereafter returns. In some embodiments the provisioning process is initiated by sending a message to another application. In some embodiments the other application is part of or associated with an application that manages provisioning of the selected alternative app. In some embodiments the other application is part of or associated with an identity provider system. In some embodiments, however, the process performs the provisioning flow for the selected alternative app. If one of the alternative apps have not been selected, the process also returns.

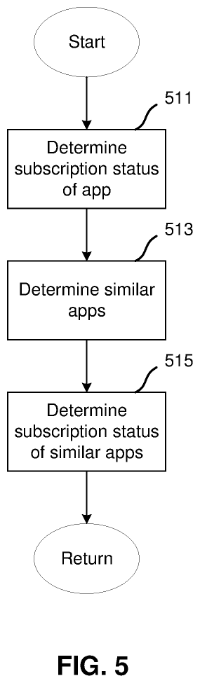

FIG. 5 is a flowchart of an example process for determining suggestions to a user as to alternative apps that may be used instead of an app initially chosen by the user. In some embodiments the process implements operations of block 415 of the process of FIG. 4. In some embodiments the process of FIG. 5 is performed by a system, for example the system of FIG. 1. In some embodiments the process is performed, at least in part, by a server, for example the server 313b of FIG. 1. In some embodiments the process is performed, at least in part, by a user compute device, for example a user compute device of FIG. 1. In some embodiments the process is performed by one or more processors programmed by program instructions.

In optional block 511 the process determines subscription status of an app for which a user compute device has loaded a subscription page. In some embodiments the process determines subscription status of the app by querying access rights management software, or a database maintained by such software, utilized by the organization of which the user is part. In some embodiments the process determines subscription status of the app by querying identity provider software, or a database maintained by such software, utilized by the organization of which the user is part. In some embodiments the process determines subscription status of the app by querying accounting software, or a database maintained by such software, utilized by the organization of which the user is part. In some embodiments the subscription status is whether the organization has a subscription to the app, and, if so, in some embodiments a number of seats remaining available for use by the organization.

In block 513 the process identifies alternative apps that may be used instead of the app for which the user compute device has loaded a subscription page. In some embodiments the process maintains a table, database, or other data structure which lists a plurality of apps and, for each of a plurality of apps, lists apps which include similar functionality to those apps. In some embodiments the process maintains a table, database, or other data structure which correlates apps with similar functionality.

In optional block 515 the process determines subscription status, for the organization, of the alternative apps. In some embodiments the process determines subscription status of each of the alternative apps by querying access rights management software, or a database maintained by such software, utilized by the organization of which the user is part. In some embodiments the process determines subscription status of each of the alternative apps by querying identity provider software, or a database maintained by such software, utilized by the organization of which the user is part. In some embodiments the process determines subscription status of each of the alternative apps by querying accounting software, or a database maintained by such software, utilized by the organization of which the user is part. In some embodiments the subscription status is whether the organization has a subscription to the app, and, if so, in some embodiments a number of seats remaining available for use by the organization.

The process thereafter returns.

Although the invention has been discussed with respect to various embodiments, it should be recognized that the invention comprises the novel and non-obvious claims supported by this disclosure

What is claimed is:

1. A method of providing application software program (“app”) usage suggestions, comprising:
identifying an app desired to be used by a user using a user compute device;
identifying alternative apps which provide similar functionality to the app;
presenting an indication, on the user compute device, of the alternative apps which provide similar functionality to the app; and
receiving a selection, by the user compute device, for use of the app or a one of the alternative apps.

2. The method of claim 1, wherein the app is identified based on loading of a subscription web page for the app in a browser of the user compute device.

3. The method of claim 2, wherein a plug-in for the browser identifies the app based on the loading of the subscription web page for the app.

4. The method of claim 2, wherein the plug-in for the browser detects loading of the subscription page by examining page content of loaded pages.

5. The method of claim 4, wherein the plug-in for the browser detects loading of the subscription web page by examining page content of loaded pages for log-in fields.

6. The method of claim 4, wherein the plug-in for the browser identifies the app based on information of a title of a loaded subscription page.

7. The method of claim 1, wherein the app is identified based on selection of use of the app by the user compute device.

8. The method of claim 7, wherein the user compute device includes an agent that monitors for user selection of apps.

9. The method of claim 8, wherein the agent comprises network monitoring software.

10. The method of claim 1, further comprising sending a message, by the user compute device, to a server indicating the identified app.

11. The method of claim 10, wherein the server identifies the alternative apps which provide similar functionality to the app.

12. The method of claim 1, wherein the identifying alternative apps which provide similar functionality to the app uses a data structure includes information correlating apps which provide similar functionality.

13. The method of claim 12, further comprising identifying apps for inclusion in the data structure based on information stored by one, some, or all of user registry systems, identity processing systems, and/or supply chain management systems.

14. The method of claim 12, wherein the data structure includes information as to access requirements for the apps.

15. The method of claim 14, wherein the access requirements for the apps includes a number of seats remaining for the apps.

16. The method of claim 15, wherein the identified alternative apps are limited to only those apps which do not exceed a number of seats remaining.

17. The method of claim 1, wherein the user compute device identifies the alternative apps which provide similar functionality to the app based on information downloaded from a server.

18. A system for providing application software program (“app”) usage suggestions, comprising:
a server configured by program instructions to:
receive an indication that a user compute device obtained a subscription page for an application software program (“app”),
determine other apps that have similar functionality to the app; and
provide information regarding the other apps to the user compute device.

19. The system of claim 18, wherein the server is configured by program instructions to determine other apps that have similar functionality to the app based on information of a data structure including information correlating apps which provide similar functionality.

20. The system of claim 18, wherein the server is further configured by program instructions to prioritize the determined other apps based on at least one of a current domain, permissions of a user for the user compute device, and a team membership of the user of the user compute device.
